(19) United States
(12) Patent Application Publication
(10) Pub. No.: US 2010/0211500 A1
(43) Pub. Date: Aug. 19, 2010

(54) CHARITABLE GIFT CARD

(76) Inventor: David Armetta, Stamford, CT (US)

Correspondence Address: FOX ROTHSCHILD LLP;New York, 997 Lenox Drive, Bldg. #3, Lawrenceville, NJ, 08648, US

(21) Appl. No.: 12/328,489

(22) Filed: Dec. 4, 2008

(51) Int. Cl. G06Q 40/00; G06F 17/30

(52) U.S. Cl. 705/41; 235/380; 707/776; 707/E17.014

(57) ABSTRACT

The present invention provides a system and method for providing a charitable gift. The system and method receiving a payment from a gift giver for a donation of a donation amount on behalf of a gift recipient, the donation being made to a charity. The system and method includes processing the charitable donation for submission to the charity on behalf of the gift recipient. The system and method includes electronically applying charitable donation information to a gift card, including the donation amount. And the method any system includes activating the gift card for presentation to the gift recipient, the gift card including the charitable donation information.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to charitable gift giving and credit or debit based cards and more specifically the utilization of card-based financial means in conjunction with charitable gift giving.

### BACKGROUND OF THE INVENTION

Charitable giving, while a noble cause, suffers from limited means allowing individuals to donate money on behalf of others. It is common for donations to be made on behalf of others, but this suffers when the donation is made as a gift. For example, supposed person A donates $100 to a charitable cause that person B favors, under existing techniques person A makes the donation and notes that this gift is “on behalf of person B.” Person A is then required to generate some form of announcement to let person B know that a donation was made. For example, person A must print out a receipt of the donation, write a note or even in some cases, the donation recipient might send a card or notice to person B informing them that a donation was received on person B's behalf as being submitted by person A.

These techniques are extremely effective and have worked very well in channeling donated funds to various recipients. In the context of funds donation for gift purposes, these techniques suffer in two main respects. A first shortcoming is that the donor must go through additional steps to inform the giftee (the person whom on behalf the donation is made) of the donation. A second shortcoming is that if the donor wishes to give the giftee an additional gift, the donor then also has to purchase another item for giving as a gift.

In an unrelated field to charitable giving, there has been an explosion in the utilization and back-end processing relating to gift cards, wherein gift cards here primarily refer to electronic debit-based cards that can be purchased at a point of sale location and have a monetary amount assigned to the card. These cards are typically used for gift purposes, such as person A buying a card at store X, having store X crediting an amount, e.g. $50, onto the card and then person A giving the card to person B. Person B can then purchase items at store X, paying for those items with the gift card. Another available option is the purchase of a gift credit card, e.g. an American Express® gift card, where the person can then use the gift card wherever the credit card itself is available.

The growth of these gift cards is fueled by not only the back-end processing knowledge applicable to credit-based cards, e.g. the application of credit information to a magnetic strip on the card, but also the back-end processing techniques for managing the debit/credit information applicable to individual cards as well as associated retailers. For example, different types of cards are available, such as retailer-specific cards. These cards can be purchased on-site at the specific retailer and the credit amount applied thereon. On example might be a Starbucks® card purchased at a point of sale terminal, where the purchaser selects a dollar amount to be applied to the card. These cards may also be purchased outside of the redeeming entity. A common example is an iPod® gift card which can be purchased at another store, such as different denominations being available in a gift card kiosk.

The gift cards provide a convenient and effective means for gifting a particular dollar amount to someone, thus allowing the gift recipient to then spend the money on a gift, instead of the giver purchasing either a duplicative gift or an unwanted gift.

Currently though, there is no combination of these disparate concepts of charitable giving and gift giving. Existing credit processing systems do not accommodate charitable giving, as well as gift card generation. As such, there exists a need for providing gift card options for charitable giving.

### SUMMARY OF THE INVENTION

The present invention provides a method and system for a charitable gift card. Through a charitable gift card, a giver can effectuate a dual transaction of not only giving a person a gift, but also making a charitable donation part of that gift. For example, the gift giver may want to give a donation to a charity as the gift for the gift recipient. This transaction includes three parties, the gift giver who is the person purchasing the gift card, a charity being the entity receiving the donation and a gift recipient, the person on behalf of whom the charitable donation is made. The gift giver can then make a donation to the charity on behalf of the gift recipient and give the gift recipient the gift card as the present.

The method and system includes a gift card having a donation value associated therewith. The method and system includes a processing system to process payments for the donation value, including processing payments for receipt of the donation amount as well as processing donated funds to one or more designated recipients. The method and system further includes a card value distribution system for associating the donation value to the gift card based on the payment processing. The method and system further includes a donation distribution system for providing funds based on the donation value to a designated donor recipient.

The present invention may include various embodiments realizing the described charitable gift card. For example, the gift card may be a magnetic strip card similar to a credit or debit card having account information written to the magnetic strip. In another embodiment, the gift card may be other available means, such as a card having an embedded RFID tag or other type of readable sensor, the card may include a printed identification number that can be used to access back-end data storage of account information, the card may be similar to a key fob or other type of small easily-transportable device, or the card may be nothing more then an information carrier for external communication systems, e.g. such as loading information on to an Internet-based web location.

The present invention may include various techniques for user access to the gift card, including commercial point of sale transactions, web-based transactions, phone-based transactions, by way of example. Back end processing may allow for different embodiments wherein the gift card may include only a donation value or may include a donation value in addition to a credit value for a gift recipient and donation recipient. For example, a person may gift a charitable donation of a first amount on behalf of the gift recipient and also have a credit for a second amount applied to the card, thus when the gift recipient receives the gift card, they can also use the card in accordance with known gift card techniques.

These cards could be offered for sale and subsequently purchased from a point of sale display in the store, online through a website, via phone, a bank or any other suitable location. The methods would allow for sales of either a virtual or physical card and account. The card and or account would be available for recharging with the bank retaining cardholder and purchaser history including but not limited to card serial number, transaction type, account numbers and purchaser information.

The card and accounts to be purchased in-store could be either a predetermined amount and predetermined charity, or a generic card without a specific charity or amount immediately assigned. The amount and charity would be determined by the purchaser during the sales process. Some convenient method for assigning specific card account information like the charity or amount would be utilized like a UPC barcode or some other conveyance method. They could be paid for via cash, credit card, debit card account, or some other electronic transaction. They might be able to be recharged as well.

The card and accounts could also be purchased online, over the phone or in some other electronic manner and would be able to have either a predetermined amount and predetermined charity. Another technique is to start with a generic card/account and then have it customized by the purchaser. This would afford a much greater number of charities to be available as they could all be listed on a website. This customized card specifications would be determined during the sales process. They could be paid for via credit car debit card account, or some other electronic transaction. They might be able to be recharged as well.

In the customized versions, the purchaser might be able to assign any part up to all of the purchase to go to the charity. Multiple charities on a single card or account would also be available and determined by the issuing bank.

### BRIEF DESCRIPTION OF THE DRAWINGS

FIG. 1 illustrates a sample charitable gift card in accordance with one embodiment of the present invention;

FIG. 2 illustrates an exemplary system diagram of one embodiment of a web-based system for generating a charitable gift card;

FIG. 3 illustrates an exemplary system diagram of one embodiment of a point of sale-based system for generating a charitable gift card;

FIG. 4 illustrates an exemplary system diagram of one embodiment of a phone-based system for generating a charitable gift card;

FIG. 5 illustrates a flowchart of the steps of one embodiment of a method for generating a charitable gift card; and

FIG. 6 illustrates one embodiment of an aspect of the system for generating a charitable gift card.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

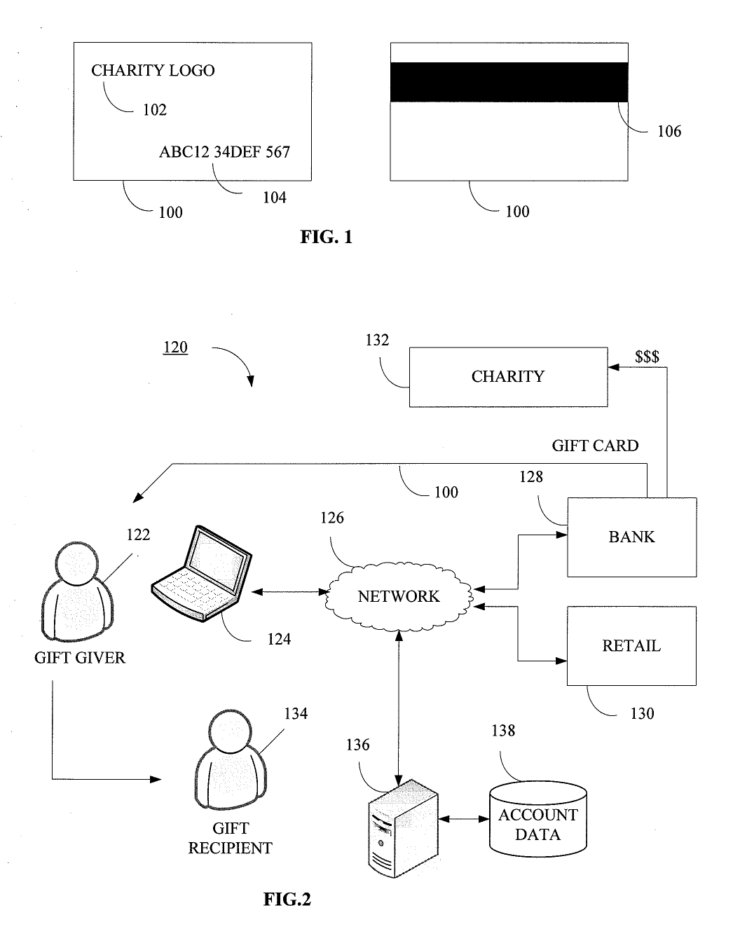

FIG. 1 illustrates a graphical representation of a charitable gift card 100, including a front view and a back view. The front side may include a logo 102, such as the example of a charity logo. The front side may also include account information 104, the information on the front of the card may be consistent with existing charitable gift cards. It is understood that the specifics on the front of the card may include any suitable type of information and is not limited to the logo 102 and/or numbers 104 illustrated.

Differentiating the card 100 from existing gift cards includes information associated on the magnetic strip 106. In accordance with known technology, the magnetic strip may store information, although in the charitable gift card 100, the information includes data usable on a back-end processing system for coordinating the dual purpose of a charitable gift and a gift card. By way of example, the charitable gift information may include personal information usable for determining tax benefits for a gift recipient, as well as information relating to the charity receiving the donation. In addition, the card may include the credit or debit-based information allowing for the card to be used in a retail transaction. As described in further detail below, the information from the card can be processed through back-end processing systems including banking systems using processing techniques for processing all levels of the financial transactions.

FIG. 2 illustrates one embodiment of an exemplary system 120 providing for a charitable gift card. The system 120 includes a gift giver 122, computer 124, network connection 126, bank 128, retail 130, charity 132, gift recipient 134, processing server 136 and account data database 138.

The gift giver 122 may be the person who purchases the charitable gift card, including paying for the gift card. The computer 124 may be any suitable type of computing device not necessarily restricted to a laptop computer illustrated, but may include other processing systems such as but not limited to smart phones, stand-alone point of sale kiosks, etc. The network 126 may be any suitable type of network capable of processing electronic payments, including for example the Internet 126. It is recognized that in the processing of financial transactions, the network 126 includes processing capabilities required for security purposes, such as for bank to bank information processing.

The bank 128 and the retail establishment 130 may be any suitable type of institution and it is recognized that these may also be the same entity where the bank includes a retail operation or the retail includes banking operations. Typically, the bank 128 issues the charitable gift card, managing the funds or credits associated with the card for a processing fee, the funds associated with the card are then made available to the retail establishment 130.

The charity 132 may be any suitable type of charitable organization. Typically, the charity will be a tax exempt charitable organization, otherwise known as a 501(c)(3) organization under the applicable tax laws, but it is recognized that the charity itself does not have to be tax exempt and the term charity generally refers to any organization wherein a person can donate money, one such example being a fund raiser opportunity, where donations for a fund raiser are not necessarily tax deductible.

The gift recipient 134 refers to the person who receives the gift card and on who's behalf the donation is made. The charity 132 receives the donation and the gift recipient 134 receives the charitable gift card indicating the donation to the charity. As described herein, processing system and computing system may include any suitable number of processing elements operative to perform noted operations in response to executable instructions. For example, one embodiment may include a computer readable medium having executable instructions stored thereon, the processing device or devices are operative to perform processing operations in response to those instructions, providing functionality in the computing environment as described herein.

In the system 120, the server 136 and account data database 138 may be any suitable type of processing system and data storage system, wherein the server 136 stores the information associated with the charitable donation and the gift card, as described in further detail below regarding the database 138.

In the system 120, the gift giver 122 enters into a financial transaction via the computer 124 across the network 126. One example may be a web site or other Internet-based portal available from the server 136, the bank 128 and/or the retail 130. The web location may be in accordance with known web techniques for retrieving user information and completing an electronic transaction.

In this electronic transaction, the giver 122 may select a charity 132 and may select a retail establishment 130. It is recognized that in one embodiment, the giver 122 may merely select a charity 132 when the charitable gift card consists only of a donation and it is also recognized that the charity/retail selection may be grouped together, such as selecting a gift card for a coffee chain may automatically include making a donation of an associated charity.

In this embodiment of FIG. 2, the gift giver 122 may also enter information about the gift recipient 134. This information may include any suitable level of information, from just a name to full contact information. The information may then be stored in the account data 138, associated with the donation and associated with the gift card 100. It is recognized that the server 136 may also collect as much information as available from the gift giver 122 and also store that information. For example, this information may be stored for gift tax purposes, if needed.

Another embodiment may include the gift giver 122 not giving any specific information about the gift recipient 134 at the time of the transaction, but rather upon receipt of the gift card, the gift recipient may consummate the donation, such as by activating the card or contacting the charity directly. One such example may be the recipient logging onto a website for the charity and entering the gift card information, another example may be a phone automated system where upon calling, the funds are donated.

The various embodiments operate on back-end processing between the bank 128, giver 122, recipient 134 and in some embodiments the retail establishment 130. The bank 128 processes the original payment and may issue or otherwise authorize or activate the gift card 120. The funds can then be managed between the charity 132 and the retail establishment 130 by allocating the funds accordingly, including in one embodiment the bank collecting processing fees associated with the financial transaction.

In the system of FIG. 2, the gift card 100 may then be sent to the gift giver 122. As this embodiment includes a web-based transaction, one technique for issuing the card may be the physical delivery of the card, such as using the U.S. Mail system. The giver 122 may then give the charitable gift card 100 to the recipient 134. The card indicates to the recipient that as part of the gift, a donation has been made or will be made to the charity 132. In another embodiment, the card 100 may be sent directly to the recipient from the bank 128, the retail establishment 130, the charity 132 or any other suitable entity.

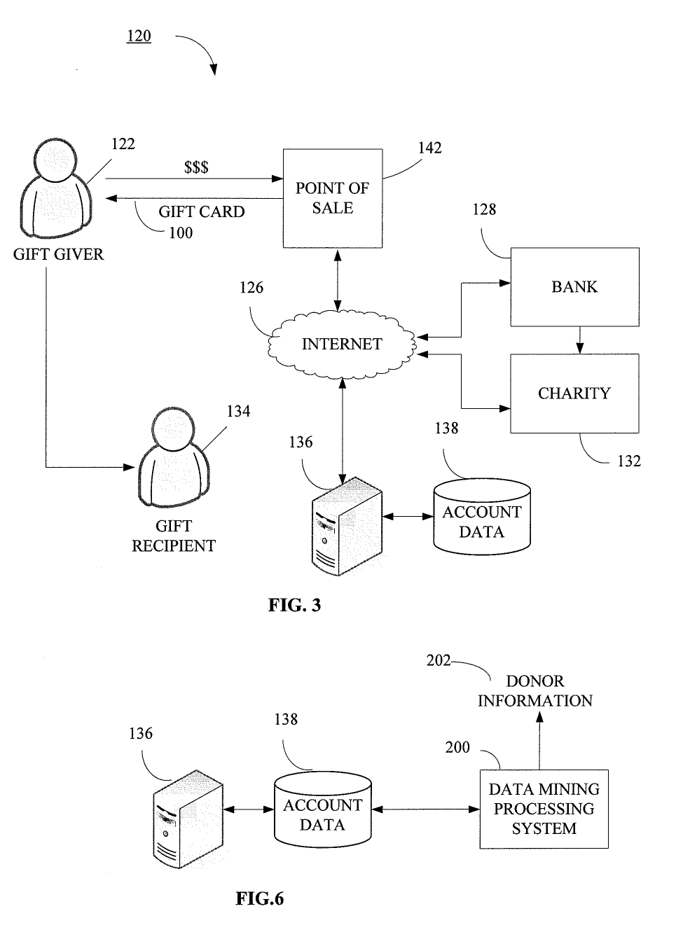

FIG. 3 illustrates another embodiment, a system 140 for giving a charitable gift card. The system 140 includes a point of sale (POS) 142 for the giver 122 to purchase the gift card 100. Similar to FIG. 2, the system 140 includes the gift giver 122, gift card 100, network connection 126, bank 128, charity 132, server 136 and account data database 138.

In the POS embodiment, the POS 142 may or may not include the retail establishment 130 of FIG. 1. For example, one embodiment includes a POS 142 where a retail establishment sells gift cards 100 that include gift card credit applicable to its own retail establishment. By way of example, supposed Starbucks® sold a charitable gift card, the card may include donations to charity 132 but also credit usable at any Starbucks® location, thus making the POS 142 the same as the retail 130 of FIG. 1.

In another example though, the POS 142 can be unrelated to the underlying retail of the charitable gift card, such as for example a kiosk or gift card rack found in a retail store. Using again the example of Starbucks®, a grocery store or a convenience store may have racks of gift cards, where the giver purchases the card in a standard retail transaction and the card is then used at a separate location. In this example, a person purchases a $25 Starbucks® gift card at a grocery store, the card is then usable at the Starbucks®, not the grocery store. In this embodiment, the bank 128 utilizes processing routines to manage the funds relative to the gift card and the various retail operations, including processing the payment from the grocery store to the bank, from the bank to the location where credit is applicable (in this example being Starbucks®), as well as then processing payments when the card is used in subsequent retail transactions.

The credit aspect of the card may be performed in accordance with known techniques, it is the inclusion of the charitable gift that provides additional processing in the bank 128 and the point of sale 142. Again, various embodiments may be utilized, such as where the giver 122 merely purchases the card at a noted value, such as printed on the card, the giver 122 may allocate a certain value and that value is written to the card. The giver 122 may also select predetermined donation amounts or may apply selected donation amounts. The giver may select a charity for the card, the card may be pre-associated with a charity, and the card may have a donation value that requires the donation value given to a charity such that the recipient may select a charity, by way of example.

In the embodiment of FIG. 3, the giver 122 may purchase the card 100 and give recipient's information in the point of sale 142, this information stored via the server 136. The recipient 134 may receive the card from the giver 122 and provide the information at a later point in time, such as when activating the card or confirming a donation.

Similar to the description of FIG. 2, the bank 128 may process the donation amount and present it to the charity 132, the donation amount determined from the financial transaction at the POS 142, minus any transaction or processing fees. In one embodiment, the giver 122 may then directly purchase the charitable gift card in a retail transaction, allocating a donation amount and a gift card amount. Both amounts are then written or allocated to the card, such as one embodiment being the writing of account information on the magnetic strip 106 of FIG. 1 on the card. One embodiment of allocating the amount may omit including reference information on the card 100, but storing account information on the bank 128 or the server 136. Another embodiment may include the storage of credit information within computing systems associated with the retail establishment and donation information in a separate system, in essence bifurcating the amounts on the card, managing the donation amount in one computing environment and managing the credit amount in another computing environment.

Regardless of which particular embodiment is utilized, the gift giver 122 may then leave the store with the gift card 100, instead of the embodiment of FIG. 2 awaiting the receipt of the gift card from the issuer.

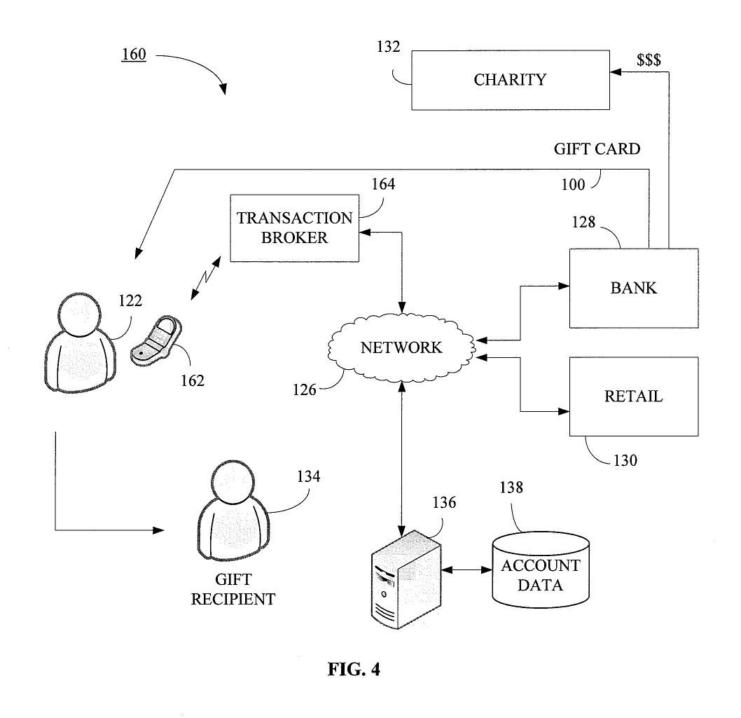

FIG. 4 illustrates another embodiment of a system for giving a charitable gift card. This embodiment includes a system 160 having similar elements to the system 120 of FIG. 2, but including a telephone for phone-based communication with the transaction broker 164. This system 160 may operate similar to the system 120 of FIG. 2 and the system 140 of FIG. 3, wherein in this embodiment the transaction for the sale of the charitable gift card can be done over a telephone line.

The system 160 includes the giver 122, a phone 162, the transaction broker 164, network 126, bank 128, retail 130, charity 132, server 136, account data database 138 and the gift recipient 134. The phone 162 is illustrated as a cell phone, but it is understood that this may be any suitable type of phone device recognized by one skilled in the art.

The system 160 includes phone-based communication, which is a commonly used technique to solicit donations by charities. A typical approach is the charity calling the giver 122, but it can also be where the giver 122 calls the transaction broker 164. As used herein, the transaction broker 164 may be the charity 132, but is illustrated as being separate because various embodiments envision using a separate entity to broker the transaction. For example, charities may employ telemarketers to call individuals. In another example, a charity may not have the overhead to cover a phone-based donation system so they contract out with a company to receive donation phone calls and process the donations to the charity.

In this embodiment, it is more likely that the charitable gift card may not have a retail credit associated therewith, but the transaction broker may be able to provide such services. Using the above example of a Starbucks® card, the broker may substitute itself in the POS 142 of FIG. 3, in transacting the purchase of a charitable gift card having a retail credit associated therewith. The processing operations for the charitable gift card 100 in this embodiment may be the same as the other embodiments described above, including upon consummation of the transaction, the charitable gift card being sent to the giver 122 for presentation to the recipient 124 or directly to the recipient 124.

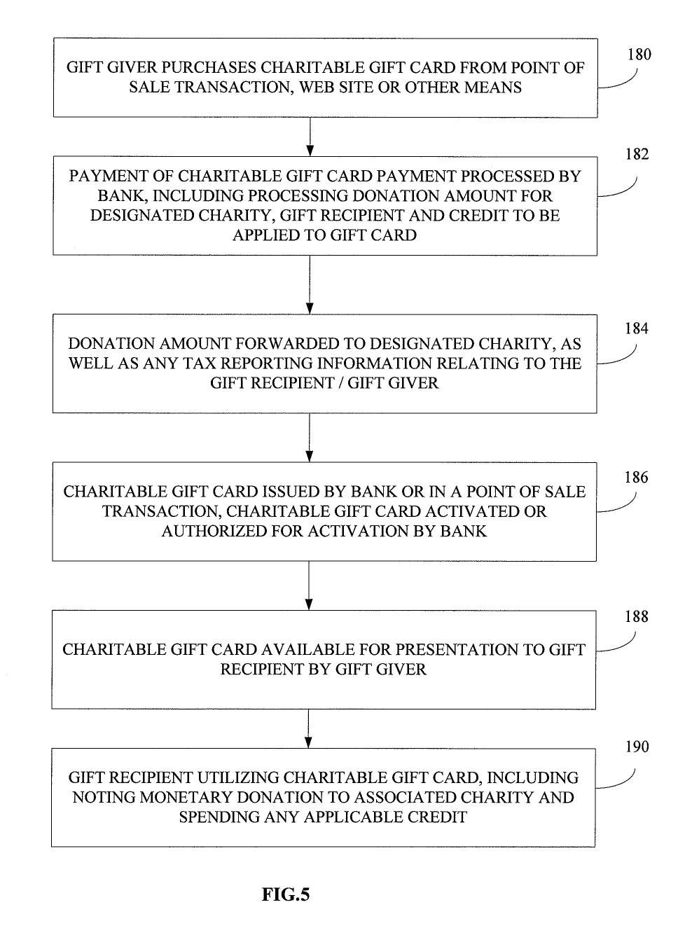

FIG. 5 illustrates a flowchart of the steps of one embodiment of a method for giving a charitable gift card. A first step, step 180, includes the gift giver purchasing the charitable gift card from a point of sale transaction, web site, or any other means. The gift giver purchases the gift card for donating a donation amount to a charity on behalf a gift recipient. The next step, step 182, includes the payment of the charitable gift card processing by a bank, including processing a donation the donation amount for the designation charity, gift recipient and credit to be applied to the card.

A next step, step 184, includes the donation amount being forwarded to the designated charity, as well as any tax reporting information relating to the gift recipient/gift giver. Step 186, the charitable gift card is issued by a bank or in a point of sale transaction, the charitable gift card may be activated or authorized for activation by a bank. As described herein, authorization for activation may include an embodiment where the recipient activates one or both of the card and/or donation upon receipt of the charitable gift card.

Step 188, the charitable gift card is available for presentation to the gift recipient by the gift giver. Where the card is purchased outside of a point of sale transaction, this may include sending of the card to the giver or the recipient. Step 190 includes the gift recipient utilizing the charitable gift card, including noting the monetary donation associated with the card and hence associated to the charity and spending any applicable credit. As noted above, various embodiments may be encompassed, including for example the recipient activating the card to present the gift to the charity, or the recipient registering the card with the charity to receive donation tax credit, the recipient activating a card and then selecting a charity, etc.

FIG. 6 illustrates an additional aspect to the present system, including a data mining processing system 200. The data mining processing system 200 accesses the account data database 138 from the server 136, wherein the database 138 receives information consistent with the techniques described above. The data mining 200 may then mine out various levels of donor information, using any suitable type of data mining technique. Via this data mining operation, new levels of information can become available based on information from the giver, as well as the recipient, of the charitable gift card.

There may exist many possibilities for using the data on both the buyer and the recipient of these cards that may be allowed for further marketing since research shows that individuals that are prone to charitable giving are prone to repeat the contributing to various causes. Each of the individuals that contact the customer service representative for the generation of the tax deductible receipt will have their information made available to the CSR and then with an opt-in during the registration process will make available their contact information for further marketing.

A certain portion of the card will be tax deductible because a predetermined amount on each individual card will be pre-coded and would be given to a 501c3 organization. Depending on the initial set-up of the card, the following scenarios would take care of the charitable contribution:

1. The recipient of the card would be able to claim the tax deduction with a receipt that would be generated online or via the phone that would give all of their information to a customer service representative about the recipient.

2. The original buyer and eventual donor of the card would be able to claim the tax deduction with a receipt that would be generated online or via the phone that would give all of their information to a customer service representative about the recipient. This version would be preferred.

3. An even split between the recipient of the card and the original buyer/eventual donor of the card would be able to claim one half of the tax deduction with receipts that would be generated online or via the phone that would give all of the information about both parties to a customer service representative about the donor and the recipient.

4. If the card is purchased online, the card would be able to be customized (special determined amounts) with generic or customized card artwork instead of a pre-determined value of the card.

The cards could come in a predetermined amount that would coincide with the most favorable pricing structures after market testing. For example:

1. $50 card=$25 charitable+$25 preloaded onto the gift card that the recipient can use at their discretion. In some instances, the remaining $25 (stored on the card for the recipient) can be used to buy another Giving Gift Card or some portion of one. The stated value on a particular card might be illustrated by issuing a $25/$25 card. Total worth of the card would be $50. Additional costs for issuing the card including transaction fees, cost of production and other ancillary costs could be paid for as follows: a: Additional cost to the overall card cost as is common today in buying gift cards. (It is currently about $4.95 per card for an American Express Gift Card) Illustration: $50+$4.95=$54.95 The Gift-Card would be worth $25, the charitable contribution would be $25 and the tax deduction would be worth $25; b: The additional costs associated with the card from above could be deducted from the charitable gift, causing the charitable gift to actually be less than the $25 in the above illustration. A disclaimer on the back of the card or on the packaging could stipulate that the actual tax deductible amount is based subtracting ancillary fees stated above from the Gift to the charitable organization, therefore reducing the amount of tax deduction for the person claiming the tax deduction. Illustration: $50=$25 Gift-Card to the recipient+$20.05 to the 501c3 organization+$4.95 to the issuer. The total available tax deduction would be $20.05 unless the card issuer gave something back to the 501c3 group as its own contribution. The issuer would get the tax deduction in this scenario; and c: The additional costs associated with the card from above could be deducted from the net gift card amount to the receiver, causing the Gift-Card to actually be less than the $25 in the above illustration. Illustration: $25 to the 501c3, $4.95 to the issuer and $20.05 to the receiver of the gift card. The tax deduction would still be $25.

2. $50 card 410 charitable+$40 preloaded onto the Gift-Card that the recipient can use at their discretion. In some instances, that $40 can be used to buy another Charitable Gift Card or some portion of one.

3. $50 card=$5 charitable+$45 preloaded onto the gift card that the recipient can use at their discretion. In some instances, that $45 can be used to buy another Charitable Gift Card or some portion of one. There may be certain rules for the minimum amount that the charitable amount may be.

4. Any combination including a card with an amount that is rounded out (like $50) and with odd amounts going to the charity so that the bank and licensing company can get paid will be possible depending on what the market testing reveals.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments.

What is claimed is:

1. A method for providing a charitable gift, the method comprising:
receiving a payment from a gift giver for a donation of a donation amount on behalf of a gift recipient, the donation being made to a charity;
processing the charitable donation for submission to the charity on behalf of the gift recipient;
electronically applying charitable donation information to a gift card, including the donation amount; and
activating the gift card for presentation to the gift recipient, the gift card including the charitable donation information.

2. The method of claim 1 further comprising:
receiving the payment from the gift giver for the donation amount and a gift credit amount; and
applying the gift credit amount to the gift card.

3. The method of claim 2, wherein the gift credit amount is a stored value usable at a retail establishment.

4. The method of claim 3, wherein the gift credit amount is pre-associated with the gift card.

5. The method of claim 3, wherein the gift credit amount is an amount determined by the gift giver and then applied to the gift card.

6. The method of claim 1 further comprising:
presenting a plurality of gift cards in a central display; and
receiving the payment from the gift giver in response to the gift giver's gift card selection.

7. The method of claim 1 further comprising:
applying the charitable donation information to a magnetic strip on the gift card.

8. The method of claim 1 further comprising:
receiving a plurality of information regarding the gift giver and the gift recipient; and
providing tax benefit information to at least one of the gift giver and the gift recipient, the tax information based on the donation amount.

9. The method of claim 8 further comprising:
performing at least one data mining operation on the plurality of information; and
assembling donor information based on the at least one data mining operation.

10. The method of claim 1, wherein processing the charitable donation includes processing a transaction fee in conjunction with the charitable donation.

11. A system for providing a charitable gift, the system comprising:
a computer readable medium having processing instructions stored thereon; and
a processing device, in response to the executable instructions, operative to:
receive a payment from a gift giver for a donation of a donation amount on behalf of a gift recipient, the donation being made to a charity;
process the charitable donation for submission to the charity on behalf of the gift recipient;
electronically apply charitable donation information to a gift card, including the donation amount; and
activate the gift card for presentation to the gift recipient, the gift card including the charitable donation information.

12. The system of claim 11, the processing device further operative to:
receive the payment from the gift giver for the donation amount and a gift credit amount; and
apply the gift credit amount to the gift card.

13. The system of claim 12, wherein the gift credit amount is a stored value usable at a retail establishment.

14. The system of claim 13, wherein the gift credit amount is pre-associated with the gift card.

15. The system of claim 13, wherein the gift credit amount is an amount determined by the gift giver and then applied to the gift card.

16. The system of claim 11 further comprising:
a central display presenting a plurality of gift cards; and
the processing device further operative to receive the payment from the gift giver in response to the gift giver's gift card selection.

17. The system of claim 11, the processing device further operative to:
apply the charitable donation information to a magnetic strip on the gift card.

18. The system of claim 11, the processing device further operative to:
receive a plurality of information regarding the gift giver and the gift recipient; and
provide tax benefit information to at least one of the gift giver and the gift recipient, the tax information based on the donation amount.

19. The system of claim 18, the processing device further operative to:
perform at least one data mining operation on the plurality of information; and
assemble donor information based on the at least one data mining operation.

20. The system of claim 11, wherein processing the charitable donation includes processing a transaction fee in conjunction with the charitable donation.
